(19) United States
(12) Patent Application Publication
(10) Pub. No.: US 2009/0103023 A1
(43) Pub. Date: Apr. 23, 2009

(54) COLOR FILTER AND METHOD FOR MANUFACTURING SAME

(75) Inventors: WEI-YUAN CHEN, Hsinchu (TW); YU-NING WANG, Hsinchu (TW); CHING-YU CHOU, Hsinchu (TW)

Correspondence Address: PCE INDUSTRY, INC.;ATT. Steven Reiss, 458 E. LAMBERT ROAD, FULLERTON, CA, 92835, US

(73) Assignee: ICF TECHNOLOGY LIMITED., Santa Clara, CA (US)

(21) Appl. No.: 12/347,245

(22) Filed: Dec. 31, 2008

Related U.S. Application Data
(63) Continuation-in-part of application No. 11/309,935, filed on Oct. 31, 2006.

(51) Int. Cl. G02F 1/13; G02F 1/1335

(52) U.S. Cl. 349/106; 349/187

(57) ABSTRACT

A color filter includes a substrate, a black matrix formed on the substrate, and a plurality of color stripes. The black matrix defines a plurality of accommodating rooms therein, and the black matrix includes carbon black in a proportion by weight of less than or equal to 55%, polymer in a proportion by weight from 15% to 95%, and additives in a proportion by weight of less than or equal to 25%. The polymer includes at least one of a fluoro compound or a siloxane compound. The plurality of color stripes are formed by an ink-jet process in the accommodating rooms. A method for manufacturing a color filter is also provided.

### CROSS-REFERENCE TO RELATED APPLICATIONS

This application claims priority under 35 U.S.C. 120, and is a continuation-in-part of U.S. patent application Ser. No. 11/309,935, filed Oct. 31, 2006, the disclosure of which is incorporated herein by reference.

### BACKGROUND

1. Technical Field

The present invention generally relates to color filters and, more particularly, to a color filter and a method for manufacturing the same.

2. Discussion of Related Art

At present, liquid crystal displays (LCDs) are used in various products, such as personal computers (PCs), mobile phones, desktop monitors, and digital cameras, due to its excellent characteristics, such as low weight, thinness, and low power consumption. The LCD includes a color filter for displaying color images. The color filter is aligned with each sub-pixel of the LCD. Colors of the color filter are typically red, green, or blue. Depending upon the image to be displayed, one or more sub-pixel electrodes are energized during display operation to allow all the incident light, none of the incident light, or part of the incident light to be transmitted through the color filter area associated with that sub-pixel. The image perceived by a user is a blend of colors formed by the transmission of light through adjacent color filter areas.

In a color filter, a black matrix is used for isolating color stripes. A material of the black matrix is metallic material such as chromium and chromium alloy, or organic material such as resin-based composition containing carbon black. However, chromium is harmful to the environment as it is a heavy metal and is toxic to living organisms. Therefore, organic material may be substituted for the metallic material.

In a conventional method for manufacturing a color filter, the black matrix is formed by exposing and developing a photoresist layer of organic material. To expose the photoresist layer completely, the photoresist layer is required to be thin while maintaining a high optical density. However, smoothness of the resulting black matrix is not satisfactory due to carbon black contained in the organic material being difficult to remove during the developing process, and is in a discontinuous phase. When ink is deposited into the accommodating rooms defined by the black matrix, the ink may easily climbs up and over the black matrix. Therefore, different-color inks may become mixed. To solve this problem, the conventional ink-jet method applies banks formed on the top of the black matrix. Therefore, this complicates the manufacturing process and the benefit of the simplicity of the ink-jet method decreases.

What is needed, therefore, is a color filter with new material for the black matrix and a method for manufacturing a color filter.

### BRIEF DESCRIPTION OF THE DRAWINGS

Many aspects of the present color filter and its related manufacturing method can be better understood with reference to the following drawings. The components in the drawings are not necessarily drawn to scale, the emphasis instead being placed upon clearly illustrating the principles of the present color filter and its related manufacturing method. Moreover, in the drawings, like reference numerals designate corresponding parts throughout the several views.

FIG. 1 is a cross-sectional view of a color filter in accordance with a first preferred embodiment; and

FIGS. 2 to 6 illustrate a manufacturing method of a color filter in accordance with a second preferred embodiment.

Corresponding reference characters indicate corresponding parts throughout the drawings. The exemplifications set out herein illustrate at least one preferred embodiment of the present color filter and its related method, in one form, and such exemplifications are not to be construed as limiting the scope of the invention in any manner.

### DETAILED DESCRIPTION OF THE INVENTION

Reference will now be made to the drawings to describe preferred embodiments of the present color filter and its related manufacturing method, in detail.

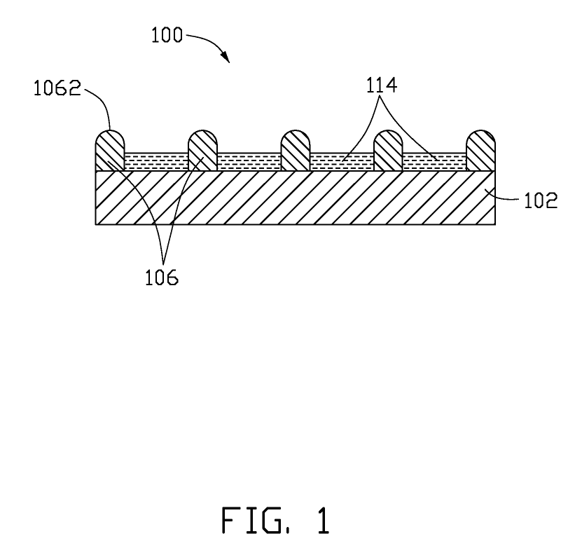

Referring to FIG. 1, a color filter 100 in accordance with a first embodiment is provided. The color filter 100 includes a substrate 102, a black matrix 106 formed on the substrate 102, and a plurality of color stripes 114 formed in accommodating rooms defined by the black matrix 106.

Preferably, the substrate 102 is a glass substrate. Preferably, a material of the black matrix 106 is a resin-based composition containing carbon black. The black matrix 106 defines a plurality of accommodating rooms therein, and the accommodating rooms are arranged in rows and columns on the color filter 100.

The black matrix 106 includes: carbon black in a proportion by weight from 0% to 55%; polymer in a proportion by weight from 15% to 95%; and additives in a proportion by weight from 0% to 25%.

Preferably, a thickness of the black matrix 106 is above 0.1 microns, and is preferably from about 0.3 to 2.5 microns.

The proportion by weight of the carbon black is preferably about 25% to 55%. If the proportion by weight of the carbon black is below 55%, the smoothness of the resulting black matrix will be enhanced.

The additives include an initiator and/or dispersant after reaction which remains in the black matrix. The initiator includes a photo initiator. The photo initiator is selected from the group consisting of 4,4-bis(dimethylamino)benzophenone, 4,4′-bis(diethylamino)benzophenone, 2-(4-methoxyphenyl)-4,6-bis(trichloromethyl)-1,3,5-triazine, and tris(trichloromethyl)-1,3,5-triazine. Photo initiators currently in use include IRGACURE® 819, IRGACURE® 369, IRGACURE® 2959, IRGACURE® 379, IRGACURE® 184, IRGACURE® 784, IRGACURE® 250, IRGACURE® 907, IRGACURE® 651, IRGACURE® OXE01, IRGACURE® OXE02, IRGACURE® 500, IRGACURE® 1800, IRGACURE® 1000, IRGACURE® 1700, DAROCURE® BP, DAROCURE® 1173 CGI 242, DAROCURE® 1173 CGI-552 (products of Ciba Specialty Chemicals, JP), Chivacure® TPO, Chivacure® TPO-L, Chivacure® 200, Chivacure® 107, Chivacure® 184, Chivacure® 284 (products of Double Bond Chemical IND., CO., LTD, TAIWAN), KAYACURE DETX-S, KAYACURE CTX, KAYACURE BMS, and KAYACURE BP-100 (products of Nippon Kayaku K. K., JP).

The proportion by weight of the polymer is preferably about 25% to 85%. The polymer includes a fluoro compound or a siloxane compound. The fluoro compound can be a non-reactive fluoro resin, a reactive fluoro monomer or a reactive fluoro oligomer. The siloxane compound can be a non-reactive siloxane resin, or a polymer of at least one of siloxane monomer and reactive siloxane oligomer. The resin-forming process is performed before the black matrix forming process. The compound forming process is performed during the black matrix forming process. The polymer as described above not only can comprise functional groups of fluorine or siloxane, but also can comprise functional groups selected from the group consisting of acrylics, hydroxyl group(—OH), hydrogencyanato(—HCN), amino group(—NH), isocyanato(—NCO), carboxy(—COOH), —SH, epoxy group, vinyl group, benzene ring, amide group, ester, usethane, siloxane, sulfide, acid anhydride, urea resin, carbonic acid, phosphate ester and sulfone. The polymer can be a polymer of fluorine-containing acrylic resin or a polymer of fluorine-containing acrylic oligomer. The polymer also can be a siloxane-containing acrylic resin or a siloxane-containing acrylic oligomer.

If the fluoro compound or the siloxane compound is non-reactive fluoro resin or non-reactive siloxane resin, the proportion by weight of the non-reactive fluoro resin or the non-reactive siloxane resin is from about 0.01% to about 30%, preferably from about 0.01% to about 5%.

If the fluoro compound or the siloxane compound is a compound of reactive fluoro monomer and reactive fluoro oligomer, or a polymer of at least one of siloxane monomer and reactive siloxane oligomer, the proportion by weight of the compound of reactive fluoro monomer and reactive fluoro oligomer or the polymer of at least one of siloxane monomer and reactive siloxane oligomer is from about 5% to a bout 95%, preferably from about 15% to about 60%.

Sufficient proportion by weight of the fluoro compound or the siloxane compound can decrease surface energy. The decreased surface energy results in weakening the hydrophilic nature of the ink, thus the color mixing problem can be solved in a certain extent. However, excessive proportion by weight of the fluoro compound or the siloxane compound will result in development remaining during the black matrix making process. The surface energy of the black matrix can be determined by the contact angle thereof detected by a detecting fluid with surface tension of 30 dyne/cm. The contact angle of the black matrix is above 20 degree, preferably, in a range from about 25 degree to 70 degree, more preferably from 35 degree to 65 degree.

The polymer also includes polymers formed by monomer or oligomer reacting with the photo-initiator. The resin includes polymethyl methacrylate (PMMA). The monomer or oligomer is selected from the group consisting of trimethylolpropane triacrylate, pentaerythritol triacrylate, pentaerythritol tetraacrylate, dipentaerythritol hexaacrylate, dipentaerythritol hexysaacrylate or any combination thereof.

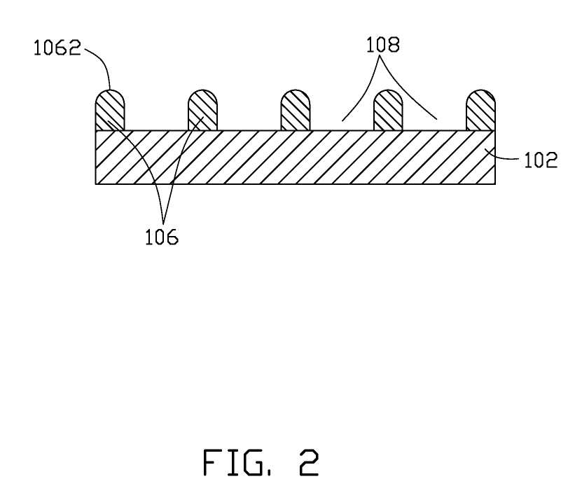

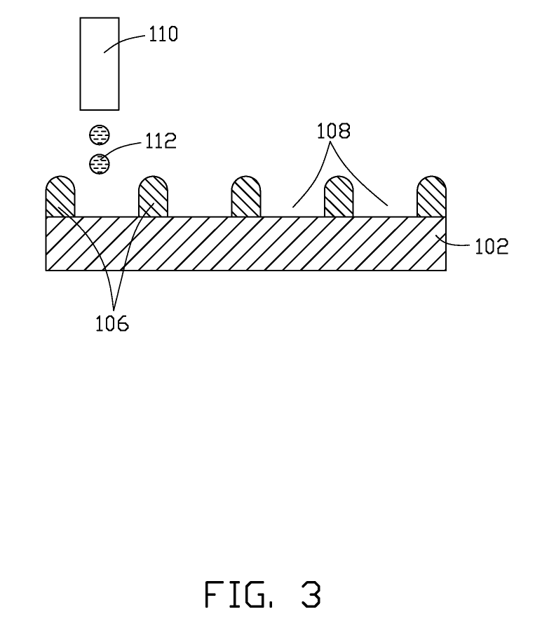

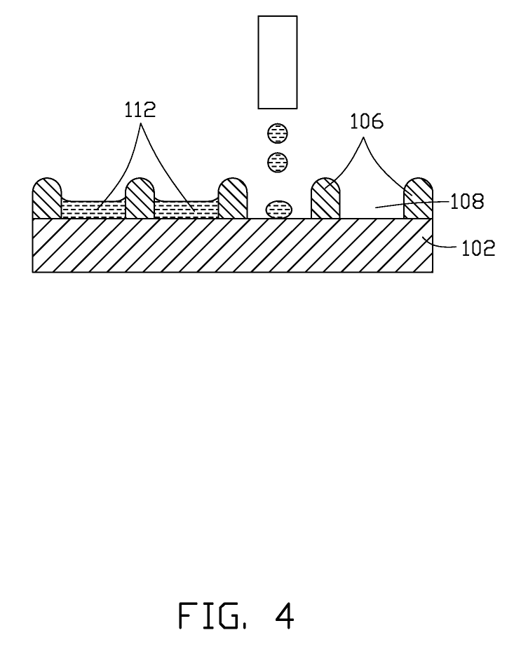

Referring to FIGS. 2 to 6, a method for manufacturing a color filter 100 according to a second preferred embodiment is shown. The method includes the steps of:

(1) forming a black matrix 106 on a substrate 102, the black matrix 106 defining a plurality of accommodating rooms 108 therein;

(2) depositing ink 112 into the plurality of accommodating rooms 108; and

(3) solidifying the ink 112 to form a plurality of color stripes 114.

In step (1), the substrate 102 is a transparent substrate, such as a glass substrate. The composition of the black matrix 106 is similar with that of the black matrix in the first embodiment.

The black matrix 106 is made by the following steps: applying an organic black photoresist layer onto a upper surface of the substrate 102 using a slit coater or a spin coater (not shown); exposing the photoresist layer using a photomask with a predetermined black-matrix pattern; developing the photoresist layer to remove non-black-matrix-pattern stripes of the photoresist layer; solidifying the photoresist layer so as to form the black matrix 106 on the substrate 102.

A thickness of the black matrix 106 is above 0.1 microns, and is preferably from about 0.3 to 2.5 microns.

Preferably, in the embodiment, the black matrix 106 has an outwardly curved top surface 1062, as shown in FIG. 2. The top surface 1062 can be formed by design of the photo mask and parameters for exposing and developing. Mixing of different-colored inks deposited in neighboring accommodating rooms 108 in the later steps can be avoided through use of the black matrix 106 with outwardly curved top surfaces 1062. The top surface 1062 of the black matrix 106 can be pyramid-shaped, conical-shaped. Also, the black matrix 106 can have an inwardly curved top surface instead of the outwardly curved top surface 1062. The top surface 1062 of the black matrix 106 can be basin-shaped. Generally, the surface 1062 of the black matrix 106 between every two accommodating rooms 108 has stripes of at least two different heights.

In step (2), ink 112 is deposited using a ink-jet device 110 into each accommodating room 108 to form ink layers 112. The ink-jet device 110 can be a thermal bubble ink-jet device or a piezoelectrical ink-jet device.

The substrate 102 moves relatively to the ink-jet device 110 so as to finish depositing the ink 112 into the accommodating rooms 108 defined by the black matrix 106.

In step (3), the ink layers 112 can be solidified by a solidifying device (not shown), such as a heating device or a light-exposure device, to form color stripes 114. The light-exposure device can be an ultraviolet light source. A heating device and a vacuum-pumping device can also be used for solidifying the ink layers 112 in the accommodating rooms 108 defined in the black matrix 106.

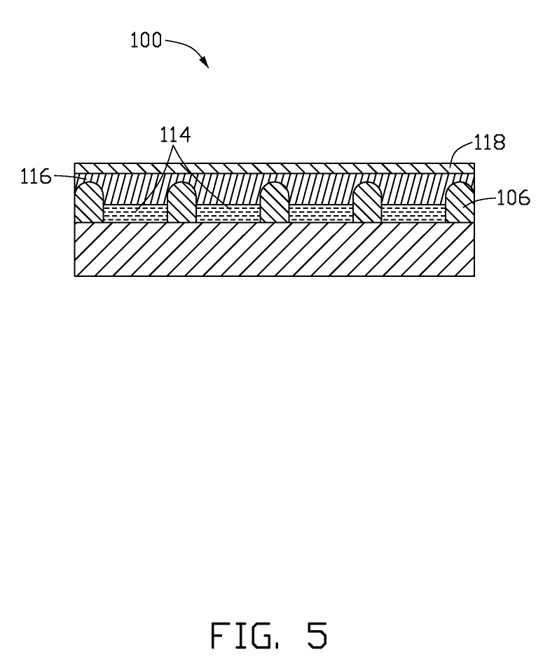

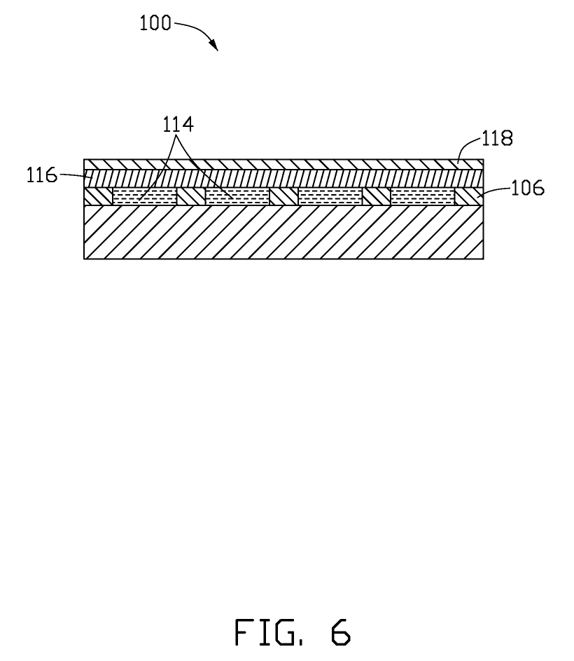

Referring to FIG. 5, an addition step following the step (3) for forming a protective layer 116 or an electrically conductive layer 118 may be performed. The portion of the black matrix higher than the color stripe 114 can be removed using a grinding method or an etching method before the protective layer 116 or the electrically conductive layer 118 is formed thereon, referring to FIG. 6. The protective layer 116 can be coated using a slit coating process or a spin coating process. The electrically conductive layer 118 can be deposited using a sputtering process. In addition, the protective layer 116 and the electrically conductive layer 118 can be formed on the black matrix 106 and the color stripe 114 sequentially.

The protective layer 116 is covers the black matrix 106 and the color stripes 114 for protection against humidity, pollution-resistance, oxidation-proof and a smoothness of the color stripes 114. The protective layer 116 is selected from the group consisting of polyimide resin, epoxy resin, acrylic resin and polyvinyl alcohol resin.

The black matrix of the color filter provided by the preferred embodiment can achieve the same effect as the banks used in a conventional method for manufacturing a color filter for avoiding mix of different-color ink depositing in neighboring accommodating rooms. Therefore, a forming step of banks on the black matrix may be omitted, thus simplifying production.

A method for manufacturing a color filter according to a third embodiment includes the steps of:

(1) providing a photoresist material comprising carbon black in a proportion of the solidifiable content by weight from 0% to 55%; a material selected from the group consisting of monomer, oligomer, and polymer, the material being in a proportion of the solidifiable content by weight from 15% to 95%, the monomer, the oligomer, or the polymer including a fluoro compound or a siloxane compound; and additives in a proportion of the solidifiable content weight from 0% to 25%;

(2) applying the photoresist material on a substrate; forming a black matrix by a photolithographic process, the black matrix defining a plurality of accommodating rooms therein;

(3) depositing ink into the plurality of accommodating rooms; and

(4) solidifying the ink to form a plurality of color stripes. The proportion of the carbon black in the solidifiable content by weight is preferably about 25% to 55%.

The proportion of the monomer, oligomer, or polymer in the solidifiable content by weight is preferably about 25% to 85%.

The monomer, oligomer, or polymer includes a fluoro compound or a siloxane compound. The fluoro compound can be a non-reactive fluoro resin, a reactive fluoro monomer, or a reactive fluoro oligomer. The siloxane compound can be a non-reactive siloxane resin, a siloxane monomer, or a reactive siloxane oligomer. The fluoro compound or the siloxane compound as described above not only can comprise functional groups of fluorine or siloxane, but also can comprise functional groups selected from the group consisting of acrylics, hydroxyl group(—OH), hydrogencyanato(—HCN), amino group(—NH), isocyanato(—NCO), carboxy(—COOH), —SH, epoxy group, vinyl group, benzene ring, amide group, ester, usethane, siloxane, sulfide, acid anhydride, urea resin, carbonic acid, phosphate ester and sulfone. The fluoro compound can be a polymer of fluorine-containing acrylic resin or a polymer of fluorine-containing acrylic oligomer. The siloxane can be a siloxane-containing acrylic resin or a siloxane-containing acrylic oligomer.

If the fluoro compound or the siloxane compound is non-reactive fluoro resin or non-reactive siloxane resin, the proportion by weight of the non-reactive fluoro resin or the non-reactive siloxane resin is from about 0.01% to about 30%, preferably from about 0.01% to about 5%.

If the fluoro compound or the siloxane compound is a compound of reactive fluoro monomer and reactive fluoro oligomer, or a polymer of at least one of siloxane monomer and reactive siloxane oligomer, the proportion by weight of the compound of reactive fluoro monomer and reactive fluoro oligomer or the polymer of at least one of siloxane monomer and reactive siloxane oligomer is from about 5% to a bout 95%, preferably from about 15% to about 60%.

The polymer also includes polymers formed by monomer or oligomer reacting with the photo-initiator. The resin includes polymethyl methacrylate (PMMA). The monomer or oligomer is selected from the group consisting of trimethylolpropane triacrylate, pentaerythritol triacrylate, pentaerythritol tetraacrylate, dipentaerythritol hexaacrylate, dipentaerythritol hexysaacrylate or any combination thereof.

More-detail steps and advantages of the method for manufacturing a color filter according to the third preferred embodiment is similar to those of the method for manufacturing a color filter according to the second preferred embodiment. Those skilled in the technical field can refer to the method for manufacturing a color filter according to the second preferred embodiment.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A color filter comprising:
a substrate;
a black matrix formed on the substrate, the black matrix defining a plurality of accommodating rooms therein, the black matrix having a composition comprising:
carbon black in a proportion by weight from 0% to 55%;
polymer in a proportion by weight from 15% to 95%; and
additives in a proportion by weight from 0% to 25%, wherein the polymer comprises at least one of a fluoro compound and a siloxane compound; and
a plurality of color stripes respectively formed in the accommodating rooms by an inkjet process.

2. The color filter as claimed in claim 1, wherein a thickness of the black matrix is above 0.1 microns.

3. The color filter as claimed in claim 1, wherein a thickness of the black matrix is in a range from 0.3 to 2.5 microns.

4. The color filter as claimed in claim 1, wherein the proportion by weight of the carbon black is in the range from 25% to 55%.

5. The color filter as claimed in claim 1, wherein the proportion by weight of the polymer is in the range from 25% to 85%.

6. The color filter as claimed in claim 1, wherein the fluoro compound includes at least one of a non-reactive fluoro resin, a reactive fluoro monomer, and a reactive fluoro oligomer.

7. The color filter as claimed as claim 1, wherein the siloxane compound includes at least one of non-reactive siloxane resin, a siloxane monomer, and a reactive siloxane oligomer.

8. The color filter as claimed in claim 6, wherein a proportion by weight of the non-reactive fluoro resin is in a range from 0.01% to 30%, and a proportion by weight of the reactive fluoro monomer and rereactive fluoro oligomer is in a range from 5% to 95%.

9. The color filter as claimed in claim 6, wherein a proportion by weight of the non-reactive fluoro resin is in a range from 0.01% to 5%, and a proportion by weight of the reactive fluoro monomer and reactive fluoro oligomer is in a range from 15% to 60%.

10. A method for manufacturing a color filter, comprising
forming a black matrix on a substrate, the black matrix having a composition comprising:
carbon black in a proportion by weight from 0% to 55%;
polymer in an proportion by weight from 15% to 95%; and
additives in an approximate proportion by weight from 0% to 25%, the polymer comprising or formed by at least one of a fluoro compound and a siloxane compound, the black matrix defining a plurality of accommodating rooms therein;
depositing ink in the plurality of accommodating rooms; and
solidifying the ink to form a plurality of color stripes.

11. A method for manufacturing a color filter, comprising the steps of:
providing a photoresist material of a black matrix, the black matrix comprising
carbon black having a proportion of the solidifiable content by weight from 0% to 55%;
a material selected from the group consisting of at least one of monomers, oligomers, and resins, the material having a proportion by weight of the solidifiable content weight from 15% to 95%; and
additives having a proportion of the solidifiable content by weight from 0% to 25%; the material comprising at least one of a fluoro compound and a siloxane compound;
applying the photoresist material on a substrate;
forming the black matrix by a photolithographic process, the black matrix defining a plurality of accommodating rooms therein;
depositing ink in the plurality of accommodating rooms; and
solidifying the ink to form a plurality of color stripes.

12. The method as claimed in claim 11, wherein the proportion of the solidifiable content by weight of the carbon black is in the range from 25% to 55%.

13. The method as claimed in claim 11, wherein the proportion of the solidifiable content by weight of the material is in the range from 25% to 85%.

14. The method as claimed in claim 11, wherein the fluoro compound includes at least one of a non-reactive fluoro resin, a reactive fluoro monomer and a reactive fluoro oligomer.

15. The method as claimed as claim 11, wherein the siloxane compound includes at least one of non-reactive a siloxane resin, a siloxane monomer and a reactive siloxane oligomer.

16. The method as claimed in claim 14, wherein a proportion by weight of the non-reactive fluoro resin is in a range from 0.01% to 30%, and a proportion by weight of the reactive fluoro monomer and reactive fluoro oligomer is in a range from 5% to 95%.

17. The method as claimed in claim 14, wherein a proportion by weight of the non-reactive fluoro resin is in a range from 0.01% to 5%, and a proportion by weight of the reactive fluoro monomer and reactive fluoro oligomer is in a range from 15% to 60%.

18. The method as claimed in claim 11, wherein a contact angle of the black matrix is above 20 degree, when the black matrix is detected by a detecting fluid with surface tension of 30 dyne/cm.

19. The method as claimed in claim 11, wherein a contact angle of the black matrix is in a range from 25 degree to 70 degree, when the black matrix is detected by a detecting fluid with surface tension of 30 dyne/cm.

20. The method as claimed in claim 11, wherein a contact angle of the black matrix is in a range from 35 degree to 65 degree, when the black matrix is detected by a detecting fluid with surface tension of 30 dyne/cm.
